(19) United States
(12) Patent Application Publication
(10) Pub. No.: US 2006/0204198 A1
(43) Pub. Date: Sep. 14, 2006

(54) Cable splice closure

(76) Inventor: Maarten Michiels, Neerijse (BE)

Correspondence Address: BAKER & DANIELS LLP, 300 NORTH MERIDIAN STREET, SUITE 2700, INDIANAPOLIS, IN, 46204, US

(21) Appl. No.: 10/561,023

(22) PCT Filed: Jun. 8, 2004
(86) PCT No.: PCT/GB04/02437

§ 371 Date: Dec. 16, 2005

(30) Foreign Application Priority Data
Jun. 24, 2003 (GB) 0314688.3

(51) Int. Cl. G02B 6/00

(52) U.S. Cl. 385/135; 385/136

(57) ABSTRACT

A cable splice closure (10) comprising a casing (12) which is capable of being closed around a cable splice, and at least one cable retention means (24) for retaining the end of at least one cable (22) fed into the interior (20) of the closure through or adjacent to a seal (44), the said retention means (24) being capable of being tightened, in use, to hold the seal (44) against the said cable (22) to seal the closure (10) and to retain the said cable (22) substantially independently of any force applied to the retention means (24) by the casing (12).

This invention relates to a cable splice closure, a kit of parts and a cable retention unit therefor.

Many different types of cable splice closure are known. For example, International Patent Application No. PCT/GB96/00194 discloses a telecommunications cable splice closure comprising a pair of semi-cylindrical elongate casing parts which can be brought together around a cable splice to close the closure with the cable splice located in the interior of the closure. The closure includes a pair of cable retention grippers which can be operated, that is to say tightened against the surface of the cable, from the exterior of the casing parts.

The cable ends that feed into the interior of the closure are gripped by the cable grippers at respective opposite longitudinal ends of the casing by tightening the jaws of the grippers around the exterior surface of the cable. The grippers are slidably mounted in respective slots in the casing parts at the cable openings at the respective longitudinal ends of the casing.

To enclose a cable splice, strips of sealing material, which may be mastic or gel for example, are wrapped around the cables on opposite sides of the splice. Each gripper is located adjacent to a respective seal on the opposite side of the seal to the cable splice. The jaws of the cable gripper are tightened around the cable by tightening one or more screw-threaded bolts or other fastening means extending out of the casing. The cable grippers are located in the respective slots and the casing parts are brought together along their opposing longitudinal edges and secured together by threaded fasteners along the longitudinal edges of the casing parts. This arrangement allows the closure to be closed around a cable splice before it is tightly secured to the cables, thus permitting adjustments to the position of the closure with respect to the cables after it has been closed around the splice, that is to say the position of the cable splice can be adjusted within the closed enclosure before the cables that are fed into the closure are secured by tightening the jaws of the cable grippers around the exterior surface of the respective cables.

The closure described in PCT/GB/96/00194 is quite complex in construction, containing a large number of parts which have to be assembled together by the installation engineer in order to secure the splice cables to the closure and ensure that the closure is correctly sealed. Consequently, installation of a cable splice closure around a cable splice is often time-consuming and normally requires a high degree of skill and training on the part of the installation engineer. For example, the installation engineer must ensure that the gripping pressure of the jaws of the cable grippers is sufficient to prevent axial pullout of the cables from the closure but insufficient to damage the insulation or outer cladding of the cable. Similar considerations apply to the tightening of the fasteners along the longitudinal edges of the casing parts.

There is a requirement therefore to provide an improved cable splice closure which is easy to install around a cable splice, which is simple in construction, and which has only a small number of components while ensuring it is inexpensive to manufacture, that provides good environmental sealing, and that substantially prevents forces, particularly axial and bending forces, which may act on the cables, from damaging a splice enclosed by the closure. There is a further requirement to provide an improved cable splice enclosure which can be installed by hand by the installation engineer without using installation tools etc., while ensuring a pre-determined load is applied to the cables fed into the enclosure to hold the cables with respect to the closure.

According to an aspect of the present invention, there is provided a cable splice closure comprising a casing which is capable of being closed around a cable splice, and at least one cable retention means for retaining the end of at least one cable fed into the interior of the closure through or adjacent to a seal, the said retention means being capable of being tightened, in use, to seal against and retain the said cable substantially independently of any compressive force applied to the retention means by closure of the casing.

In the present invention the cable or cables fed into the interior of the closure are retained by the cable retention means to resist axial forces acting to pull the cables out of the closure; torsion; and bending. Compression of the retention means around the cable(s) is achieved substantially independently of the casing parts, that is to say the seal against the cable or cables is not directly compressed by the action of the casing parts being brought together to close the closure. The cable retention means is retained by engagement formations of the casing parts to hold the cable or cables with respect to the closure. This readily enables the cable retention means to be used for different size closures, that is to say for a range of casing sizes having engagement formations of similar size. The present invention therefore contemplates a modular type system for cable splice closures in which identical or substantially identical cable retention means are used with different size casing parts.

Preferably, the retention means is capable of being opened so that it may be placed substantially around the cable or the seal and the cable and closed to hold the seal against the cable. Preferably, the cable retention means is provided with a snap fit type closure means so that the retention means is capable of being opened and closed around the cable independently of the use of installation tools by the installation engineer.

Preferably, the retention means applies a pre-determined load to the seal and cable when closed. This readily enables uniform and complete closure of the cable retention means to be achieved. This may be implemented by the aforementioned snap fit closure means of the cable retention means which enables closure of the retention means around the cable to seal in a single operation by the installation engineer without using installation tools. This can reduce the craft sensitivity of the installation and improve the reliability of the installation and reduce the installation time.

In other embodiments the cable retention means may be closed by other fastening means such as screws or bolts or the like but these are less desirable since the quality of the installation may vary as the installation engineer may fail to fully tighten the fasteners to hold the cable retention means around the cable and seal.

In preferred embodiments, the seal is resilient so that it may be deformed to seal around the cable or cables when the cable retention means is closed. In this way compression of the seal not only acts to hold the cable with respect to the cable retention means by frictional contact with the cable but also provides an effective environmental seal between the cable retention means and the cable or cables being held by that retention means. This is particularly advantageous as cables having different diameters may be fed through the seal and retention means into the interior of the closure. Compression of the seal, to a lesser or greater extent depending upon the diameter of the cable, readily enables different size (diameter) cables to be held by compression of the seal. This is important where the cables being fed into the closure are capable of being changed, for example to reconfigure the wiring or optical fibre connections in a telecommunications network.

In preferred embodiments, the seal comprises at least one aperture or slot for receiving a length of cable being fed into the enclosure. The slot may be a radial slot so that the cable can be readily inserted in the slot from the outer periphery of the seal. Alternatively or additionally cable may be fed into the enclosure through an aperture in the seal either by threading the cable through the aperture or more preferably by providing a slit in the seal so that the seal may be opened between the aperture and the periphery of the seal for receiving the cable. Where slots or apertures are used cable blanks may be inserted into empty slots or apertures to maintain the the seal, when not all the slots/apertures are required for cables at a particular time in a particular installation.

In preferred embodiments the seal comprises an elastomeric material, preferably the seal is formed of a thermoplastic elastomer, preferably with a layer of gel or gel-type material sandwiched between outer layers of thermoplastic elastomer.

In preferred embodiments the cable retention means substantially surrounds the seal and cable when in the closed position. Preferably, the cable retention means comprises at least two clamping members which are capable of being brought together to hold the seal against the cable. More preferably the cable retention means comprises a pair of clamping members which are pivotally movable with respect to one another. Preferably, the pair of clamping members are hinged together so that the cable retention means constitutes a single modular component of the cable splice closure of the present invention.

Preferably, the clamping members are generally arcuate so that they are capable of surrounding the cable and seal when they are brought together. In preferred embodiments the clamping members comprise a pair of semi-circular type half shells which, when they are brought together, provide an aperture in the form of a central bore in which the seal is located and through which the cable or cables are fed into the interior of the closure.

Preferably, the clamping members are held together by fastening means. The fastening means may be hand operated. A preferred fastening means comprises a latch and a preferred latch comprises an over the centre type latch. The term “over the centre” refers to the type of latch where the latch is biased away from a centre position in both directions such that an increasing closing force is first required to move the latch to its centre position where the force acting on the latch is a maximum and then reduces as it is moved from the centre to its closed position.

Preferably, the retention means is retained in the interior of the closure by engagement with the casing parts. The casing parts may be provided with integral engagement features for engagement with the cable retention means, for example slots or cavities or the like for receiving the cable retention means. Such engagement features may be incorporated in the casing parts during manufacture, for example integrally moulded with the casing parts in embodiments where the casing parts are moulded. The retention means may be sealed therein by known sealing materials to enhance sealing of the closure as a whole.

In preferred embodiments, the casing parts comprise a pair of half shells which are capable of being brought together along respective opposing edges thereof to close the closure. This readily enables the cable splice to be positioned in one of the two half shells before the other half shell is fitted to close the closure. In preferred embodiments the half shells are hinged together so that the shells can be readily closed.

In preferred embodiments, the casing parts are provided with latch means for holding the parts together and thereby retaining the cable retention means in the interior of the closure. Preferably the latch means comprises an over the centre type latch so that the casing parts may be readily brought together and closed in a simple and effective manner without the use of installation tools.

In preferred embodiments the casing parts comprise at least one open end for feeding the cable into the interior of the closure, and at least one of the cable retention means is positioned at the or each open end for closing the end of the closure. In this way the cable retention means also provides an end closure for the cable splice closure casing parts. In embodiments where two or more cable retention means are provided at one end of a cable splice closure a further environmental seal may be provided between the cable retention means by introducing a gel or mastic type sealant in the region between the two cable retention means. In this way moisture or other contaminants can be prevented from entering the region of the closure containing the cable splice from the open end or ends of the casing parts.

According to another aspect of the invention there is provided a kit of parts for enclosing a cable splice comprising:
a casing which is capable of being closed to close the closure;
at least one compressible seal; and,
at least one cable retention means for retaining the end of at least one cable fed into the interior of the closure through or adjacent to a compressible seal, the said retention means being capable of being tightened, in use, to compress the seal around the said cable to retain the said cable substantially independently of any force applied to the retention means by the casing.

According to another aspect of the invention there is provided a cable retention unit for a cable splice enclosure of the type having at least two casing parts which are capable of being brought together to close the closure, the retention means being capable of being opened so that it may be placed substantially around a cable or cables to be retained, and comprising closure means for applying a pre-determined clamping load to the cables when the retention unit is closed.

Various embodiments of the present invention will now be more particularly described, by way of example only, with reference to the accompanying drawings, in which:

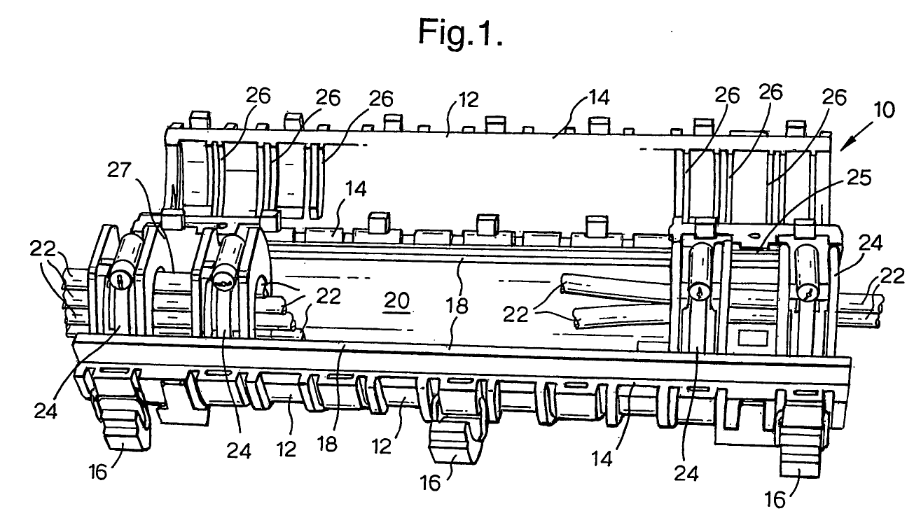

FIG. 1 shows an open cable splice closure according to an embodiment of the present invention;

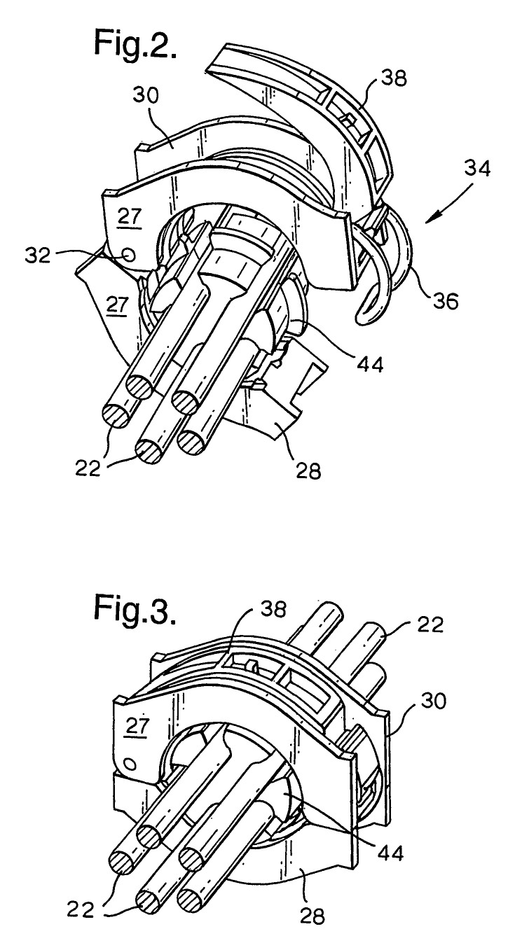

FIG. 2 is a perspective view of a cable retention unit for the closure of FIG. 1, with the cable retention means in an open configuration;

FIG. 3 is a perspective view of the cable retention means of FIG. 2 in a closed configuration;

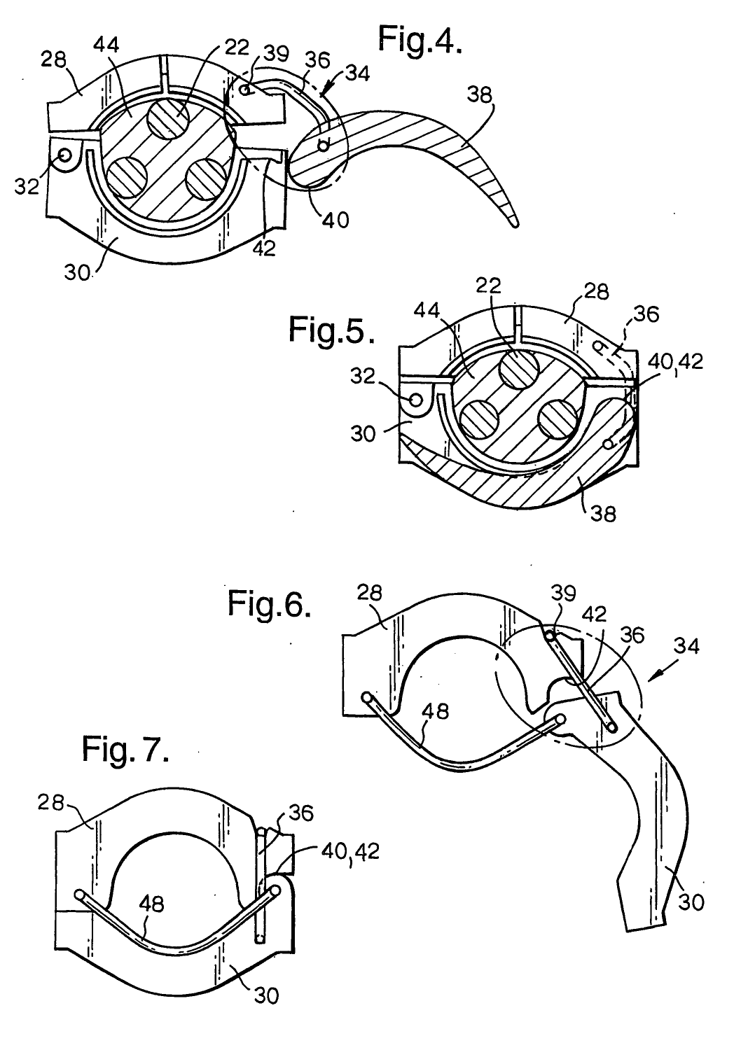

FIGS. 4 and 5 are cross-section views of the cable retention unit of FIGS. 2 and 3 shown in open and closed configurations; and

FIGS. 6 and 7 are cross-section views of another cable retention unit similar to that shown in FIGS. 2 and 3.

Referring to FIG. 1, a cable splice closure 10 according to an embodiment of the present invention comprises a pair of half shell half cylinder casing parts 12 which are capable of being brought together along their respective longitudinal edges 14 to close the closure. The casing parts each define one half of a hollow cylindrical casing which is provided on its exterior surface with a plurality of fastening means 16 spaced apart along the length of the casing for fastening the two parts together. The fastening means 16 in this particular embodiment are hand operable over the centre type latches which apply a pre-determined clamping force to the casing parts to hold the casing parts together. As shown in FIG. 1 three such latches 16 are provided on one side of the casing only with the casing parts being hinged together along their edges on the other side of the casing. Sealing strips 18 which may comprise elastomeric material are provided along the adjoining longitudinal edges of the casing parts to seal the interior 20 of the closure when the casing parts are brought together.

Cable ends 22 extend into the interior of the closure and form part of a cable splice. In the illustration of FIG. 1 only the cable ends are shown for the purpose of illustrating the present invention. It will be readily understood, however, by those skilled in the art, that the cable ends are joined together by known connectors to form in a cable splice positioned within the interior of the closure between the ends of the cables shown.

The cable ends 22 pass into the interior of the closure and are retained with respect to the closure by four cable retention units 24 which are positioned in pairs near the respective axial ends of the casing parts. The cable retention units 24 of each pair are spaced apart at each respective end of the closure by an amount substantially equal to the axial dimension of each retention unit. The region 25 between the retention units 24 at each end of the closure is provided for receiving sealing material such as gel or other suitable material for providing an environmental seal at the respective ends of the closure.

The cables are held by the cable retention units so that they resist axial pullout forces acting on the cables and also bending and torsion of the cables. The cable retention units hold the ends of the respective cables substantially independently of any force that is applied to the retention units by closure of the casing parts. Thus, no load, or substantially load, is transferred in the assembled closure between the casing parts and the cables fed into the closure.

As can be seen in FIG. 1, the cable retention units are located in the interior of the closure by engagement with radial protrusions 26 on the interior surface of the casing parts. The protrusions 26 engage the axial side surfaces 27 of the retention units to prevent axial movement of the retention units within the interior of the closure.

The manner in which the cables are retained by the cable retention units will now be described. Referring to FIG. 2, each cable retention unit 24 comprises a pair of semi-circular shaped clamping members 28 and 30 which are hinged together on one side thereof by a pin 32 so that they may be opened and closed, that is to say moved away from each and brought together. The semi-circular clamping members 28 and 30 provide a substantially circular cross-section central bore through which the cable ends 22 are fed into the enclosure. On the opposite side of the cable retention unit to the hinge 32 the clamping members are provided with an over the centre type latch 34 which comprises a stainless steel U-shaped clip or ring 36 and a lever member 38. The clip 36 is pivotally connected to the proximal end of the lever and extends circumferentially so that it may engage a suitable protrusion 39 on an engaging part of the clamping member 28. The lever 38 is provided with a cam surface 40 (as shown in FIGS. 4 and 5) which cooperates with a similarly shaped cam surface 42 on the exterior of clamping member 30 to bring the clamping members together when the lever is pivoted towards the clamping member 30.

The cable retention unit 24 is thus capable of being opened to be placed around cables 22 fed into the interior of the closure and closed by means of the over the centre latch 34 to retain the cables with respect to the retention unit. Retention of the cables is achieved by compression of a sealing element 44 positioned around the cables in the interior bore of the cable retention unit. As can best be seen in the drawing of FIG. 3, the sealing element 44 comprises a series of radial slots for receiving respective cable ends such that the cables are substantially surrounded by the compressible sealing element prior to closure of the retention unit 24. The sealing element preferably comprises a gel type material surrounded by a thermoplastic elastomer outer layer.

Closure of the cable retention unit 24 using the over centre latch 34 causes the clamping members 28 and 30 to be brought together compressing the sealing element 44 around the outer periphery of the cables until a pre-determined clamping load is applied to the cables through the compressed sealing element when the clamping members are brought together to the fully closed position as shown in FIG. 3. In this position movement of the cables with respect to the retention unit is resisted by the compression forces acting in the sealing element against the cables. In the closed position shown in FIG. 3 the sealing element therefore not only acts to retain the cables but also provides an environmental seal to prevent or substantially prevent ingress of moisture and/or other contaminants into the interior of the enclosure. It is to be understood that the lever 38 and loop type clip 36 are detachable from the clamping members since the clip 36 is arranged to hook over the protrusion 39 (or other engagement means) to attach itself and the lever to the clamping member 28.

FIGS. 6 and 7 show a slightly modified cable retention unit 24 where the over centre latch is incorporated in the clamping members 28 and 30. In this arrangement the cam surface 42 is provided on the clamping member 28 and the lever 38 is replaced by the clamping member 30 with the cam surface 40 provided on the clamping member 30. In this arrangement the two clamping members are not hinged together but are pivotally connected together by means of a pressing lever 48. The lever 48 joins opposite sides of the clamping members 28 and 30 together. The cable retention unit of FIGS. 6 and 7 is closed by engagement of the respective cam surfaces 40 and 42 and rotation of the clamping member 30 about the engaging cam surfaces towards the clamping member 28. Rotation of the clamping member 30, which now acts as a lever, brings the clamping members 28 and 30 together and tensions the hook 36 so that the clamping members are held together in the closed position shown in FIG. 7.

In the embodiments described with reference to FIGS. 2-7 the cable retention unit 24 is provided with an over the centre type latch 34 so that the retention units may be applied to the cables in a simple installation operation without the use of installation tools. However, in the arrangement shown in FIG. 1 the clamping members 28 and 30 are secured together by means of fastening screws 50 such that tightening of the screws causes the sealing element 46 to be compressed around the cables being fed into the enclosure.

Preferably the cable retention units described herein are moulded polycarbonate or polyacetal material.

Although aspects of this invention have been described with reference to the embodiments shown in the accompanying drawings, it is to be understood that the invention is not limited to those precise embodiments and that various changes and modifications may be effected without further inventive skill and effort. For example, the closure casing may be a one-piece integral structure such as a flexible and resilient tubular element that is split along its length so that it may be opened to receive one or more cable retention units 24. The one-piece casing may be of a resilient elastomeric material such as rubber.

1. A cable splice closure comprising a casing which is capable of being closed around a cable splice, and at least one cable retention means for retaining the end of at least one cable fed into the interior of the closure through or adjacent to a seal, the said retention means being capable of being tightened, in use, to seal against and retain the said cable substantially independently of any compressive force applied to the retention means by the casing.

2. A cable splice closure as claimed in claim 1 wherein the retention means is capable of being opened so that it may be placed substantially around the cable or the seal and the cable and closed to hold the seal against the cable.

3. A cable splice closure as claimed in claim 2 wherein the said retention means applies a predetermined load to the seal and cable when closed.

4. A cable splice closure as claimed in claim 1 wherein the seal is resilient.

5. A cable splice closure as claimed in claim 1 wherein the seal comprises at least one aperture or slot for receiving a length of cable being fed into the closure.

6. A cable splice closure as claimed in claim 1 wherein the seal comprises an elastomeric material.

7. A cable splice closure as claimed in claim 6 wherein the seal comprises a layer of gel type material and an outer layer of elastomeric material.

8. A cable splice closure as claimed in claim 6 wherein the elastomeric material comprises a thermoplastic elastomer.

9. A cable splice closure as claimed in claim 1 wherein the retention means substantially surrounds the seal and cable.

10. A cable splice closure as claimed in claim 1 wherein the retention means comprises at least two clamping members which are capable of being brought together to hold the seal against the said cable.

11. A cable splice closure as claimed in claim 10 wherein the said retention means comprises a pair of clamping members which are pivotally movable with respect to each other.

12. A cable splice closure as claimed in claim 11 wherein the said clamping members are hinged together.

13. A cable splice closure as claimed in claim 11 wherein the said clamping members are generally arcuate so that they are capable of surrounding the said cable and seal when brought together.

14. A cable splice closure as claimed in claim 11 wherein the clamping members are connected together to provide a clamping ring around the said cable when brought together.

15. A cable splice closure as claimed in claim 10 wherein the said clamping members are held together by fastening means.

16. A cable splice closure as claimed in claim 15 wherein the said fastening means is/are hand operable.

17. A cable splice closure as claimed in claim 15 wherein the said fastening means comprises a latch.

18. A cable splice closure as claimed in claim 17 wherein the said latch comprises an over the centre type latch.

19. A cable splice closure as claimed in claim 1 wherein the said retention means is retained in the interior of the closure by engagement with the said casing.

20. A cable splice closure as claimed in claim 1 wherein the casing parts comprise a pair of half shells which are capable of being brought together along respective opposing edges thereof to close the closure.

21. A cable splice closure as claimed in claim 1 wherein the said casing is provided with fastening means for holding the casing in a closed configuration thereby retaining the said retention means in the interior of the closure.

22. A cable splice closure as claimed in claim 1 comprising a plurality of said cable retention means.

23. A cable splice closure as claimed in claim 1 wherein the casing comprises at least one open end for feeding the said cable into the interior of the closure, and at least one of the said cable retention means is positioned at the or each open end for closing that end of the closure.

24. A cable splice closure as claimed in claim 23 wherein a pair of cable retention means are provided, in spaced relation, at the or each open end of the closure.

25. A cable splice closure as claimed in claim 1 wherein the casing comprises at least two casing parts which are capable of being brought together to close the closure.

26. A kit of parts for enclosing a cable splice comprising
a casing which is capable of being closed to close the closure;
at least one compressible seal; and,
at least one cable retention means for retaining the end of at least one cable fed into the interior of the closure through or adjacent to a compressible seal, the said retention means being capable of being tightened, in use, to compress the seal around the said cable to retain the said cable substantially independently of any force applied to the retention means by the casing parts.

27. A cable retention unit for a cable splice closure of the type having at least two casing parts which are capable of being closed around a cable splice, the retention unit being capable of being opened so that it may be placed substantially around a cable or cables to be retained, and comprising closure means for applying a pre-determined clamping load to the cables when the retention unit is closed.

28. A cable retention unit as claimed in claim 27 wherein the closure means comprises at least one over the centre latch means.
